(19) United States
(12) Patent Application Publication
(10) Pub. No.: US 2024/0244322 A1
(43) Pub. Date: Jul. 18, 2024

(54) UNCONSTRAINED IMAGE STABILISATION

(71) Applicant: Opteran Technologies Limited, Sheffield, South Yorkshire (GB)

(72) Inventors: Matthew Thomas Watson, Sheffield, South Yorkshire (GB); Alexander John Cope, Sheffield, South Yorkshire (GB)

(73) Assignee: Opteran Technologies Limited, Sheffield, South Yorkshire (GB)

(21) Appl. No.: 18/563,185

(22) PCT Filed: Apr. 26, 2022
(86) PCT No.: PCT/GB2022/051055

§ 371 Date: Nov. 21, 2023

(30) Foreign Application Priority Data
May 25, 2021 (GB) 2107427.3

(51) Int. Cl. H04N 23/68; G06T 7/215; G06V 10/774

(52) U.S. Cl. CPC H04N 23/6811; G06T 7/215; G06V 10/774; H04N 23/6812; H04N 23/683; H04N 23/689; G06T 2207/20024; G06T 2207/20081; G06T 2207/20201

(57) ABSTRACT

Herein describes a system, apparatus and methods for stabilising motion data, comprising receiving data associated with the objects from one or more sources; establishing, from said data, a rotationally stable field of view using one or more techniques; encoding the stable field of view based on one or more data structures, wherein said one or more data structures comprise at least one, two or more dimensional projection; and extracting motion data from the encoded stable field of view, wherein the motion data is stabilised.

The present application relates to a system, apparatus and method(s) for performing unconstrained electronic image stabilisation and omnidirectional camera fusion, namely for use in robotics and smart camera applications.

### BACKGROUND

Image stabilisation generally refers to moving a cropping window around the image to make the contents of the cropped image appear stationary or physically actuating elements of the (camera) lens to move the image on the sensor plane. Image stabilisation may also be associated with using mechanical gimbals to stabilise a camera or image from the camera.

In the context of robotics and smart camera applications, it is often crucial for the robot or sensor to perceive the sounding visual information in a stable manner, i.e. capturing a stable field of view of the world. This is achievable through image stabilisation.

However, present methods for image stabilisation are generally effective for rotations in the order of a few degrees only, either due to mechanical and optical limitations preventing further lens rotation, or due to excessive cropping in the electronic case.

In particular, the traditional (or optical) electronic stabilisation approaches are operated only over a small range of angles, limited by either lens actuator mechanical limitations in the optical case, or by excessive image cropping in the electronic case. These approaches also lack a built-in solution for stitching multiple camera images into a single field of view—instead has to be handled by feature matching.

In terms of using mechanical gimbals to stabilise a camera, i.e. applying multiple actuators external to the camera physically to counteract rotation, allowing for unconstrained rotation about the camera also poses issues. The mechanical gimbals tend to be mechanically complex, expensive, power-hungry, and notably heavy; stabilisation bandwidth limited by actuator power and total system weight; stabilisation dynamic range limited by actuator speed; it requires further computation for stitching multiple camera images into a single field of view.

Further, present approaches for encoding a system's field of view do not exhibit certain properties, some of which may even be undesirable, making these approaches relatively inferior to the present invention.

For these above reasons, it is desired to develop a method, system, medium and/or apparatus that performs unconstrained electronic image stabilisation and omnidirectional camera fusion that can address at least the above issues and produce quality emulation of stabilisation achieved in nature.

The embodiments described below are not limited to implementations, which solve any, or all of the disadvantages of the known approaches described above and throughout this application.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

The present invention provides exemplary methods for the rotational stabilisation of a field of view, data structures for encoding a field of view which exhibit desirable properties with respect to performing computation on the data, improving the extraction of scene motion by using stabilisation to eliminate apparent motion that is due to camera rotation, and methods of efficiently performing computation on a field of view encoded using these data structures.

In a first aspect, the present disclosure provides a computer-implemented method for stabilising motion data, the method comprising: receiving data associated with the objects from one or more sources; establishing, from said data, a rotationally stable field of view using one or more techniques; encoding the stable field of view based on one or more data structures, wherein said one or more data structures comprise at least one, two or more dimensional projection; and extracting stable motion data from the encoded stable field of view.

In a second aspect, the present disclosure provides a computer-implemented method of stabilising data for motion detection comprising: receiving data associated with the objects from one or more sources; establishing, from said data, a rotationally stable field of view using one or more techniques; encoding the stable field of view based on one or more data structures, wherein said one or more data structures comprise at least one, two or more dimensional projection; and extracting motion data from the encoded stable field of view for detecting motion in said data.

In a third aspect, the present disclosure provides an apparatus for detecting motion, comprising: an interface for receiving data from one or more sources; one or more integrated circuits configured to: establish, from said data, a stable field of view using one or more techniques; encode the stable field of view based on one or more data structures, wherein said one or more data structures comprise a two or more dimensional projection; and extract motion data from the encoded stable field of view to detect object motion in said data.

In a fourth aspect, the present disclosure provides a system for detecting motion, comprising: a first module configured to establish, from said data, a stable field of view using one or more techniques; a second module configured to encode the stable field of view based on one or more data structures, wherein said one or more data structures comprise a two or more dimensional projection; and a third module configured to extract motion data from the encoded stable field of view for detecting object motion in said data.

The methods described herein may be performed by software in machine-readable form on a tangible storage medium e.g. in the form of a computer program comprising computer program code means adapted to perform all the steps of any of the methods described herein when the program is run on a computer and where the computer program may be embodied on a computer-readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Any feature herein described may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a flow diagram illustrating an example of data stabilisation for motion detection;

FIG. 2 is a schematic diagram illustrating an example of RGB or non-RGB data stabilisation;

FIG. 3 is a pictorial diagram illustrating examples of 2-D projections;

FIG. 4 is a pictorial diagram illustrating an example of Double pixelisation HEALPix with N_SIDE=4, a Mollweide projection;

FIG. 5 is a pictorial diagram illustrating an example Double pixelisation HEALPix with N_SIDE=4, Azimuthal Orthographic projection;

FIG. 6 is a pictorial diagram illustrating an example of Double pixelisation HEALPix pixel boundaries, Azimuthal Orthographic projection;

FIG. 7 is a pictorial diagram illustrating an example of Double pixelisation HEALPix with band 0, Mollweide projection;

FIG. 8 is a schematic diagram illustrating an example of Double pixelisation HEALPix with band 1, Mollweide projection;

FIG. 9 is a pictorial diagram illustrating an example of Double pixelisation HEALPix with band 2, Mollweide projection;

FIG. 10 is a pictorial diagram illustrating an example of Double pixelisation HEALPix with band 0, Azimuthal Orthographic projection;

FIG. 11 is a pictorial diagram illustrating an example of Double pixelisation HEALPix with band 1, Azimuthal Orthographic projection;

FIG. 12 is a pictorial diagram illustrating an example of Double pixelisation HEALPix with band 2, Azimuthal Orthographic projection;

FIG. 13 is a block diagram of a computing device or apparatus suitable for implementing embodiments of the invention;

FIG. 14 is a graphical representation of one example of a training dataset used with a machine learning model; and

FIG. 15 is a graphical representation illustrating the same example of the training data after pre-processing by an exemplary data structure.

Common reference numerals are used throughout the figures to indicate similar features.

### DETAILED DESCRIPTION

Embodiments of the present invention are described below by way of example only. These examples represent the suitable modes of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

The present invention involves the creation of a fully rotationally stabilised field of view or a stable field of view from one or more sources or camera sources such as on a robot or detector device. The stable field of view may be established omnidirectionally. The invention uses techniques such as pixel binning and downsampling to create a rotationally stabilised omnidirectional field of view from one or more cameras, using some measurement of camera orientation. It is applicable in real-time as well as on-board. Rolling shutter correction may be further implemented as a technique to establish the fully rotationally stabilised field of view.

Provided the stable field of view, various optic flow or other motion estimation algorithms may be used to measure isolated translational motion in the perceived scene from the fully rotationally stabilised field of view and any encoding associated. The encoding may comprise any data structure—referring to any graphical representation, 2-dimensional, projection of visual data—or any projections desired herein, exhibiting a combination of properties such as those detailed in Table 1. The 2-dimensional projection of the visual data may form the basis for a 3-dimensional projection by the inclusion of depth information/data associated with each coordinate on the 2-dimensional projection. A spherical projection, either as 2-dimensional or 3-dimensional, for example HEALPix single or double pixelisation data structures, may be used, which takes advantage of the projection's equal pixel area and locally Cartesian nature. The encoded field of view may in turn be processed by or used in conjunction with optic flow type algorithms, achieving more stable and accurate predictions overall.

In general, the present invention employs the concept of unconstrained electronic image stabilisation and omnidirectional camera fusion, primarily for use in robotics and smart camera applications. This is the production of a visual field that exhibits no motion in the stabilised image when the camera is rotated by any angle about its optical centre, as opposed to the electronic and mechanical image stabilization used in photography to minimise motion blur.

### Unconstrained Image Stabilisation

Image stabilization generally refers to two different concepts. First, in photography, it is either an electronic post-processing step, or the use of an actuated lens element to minimise motion blur due to camera rotation/vibration. In the electronic case, this usually functions by moving a cropping window around the image to make the contents of the cropped image appear stationary, whereas in the optical case, this functions by physically actuating elements of the lens to move the image on the sensor plane. These methods are generally only effective for rotations in the order of a few degrees, either due to mechanical and optical limitations preventing further lens rotation, or due to excessive cropping in the electronic case.

The second common approach is in the use of mechanical gimbals to stabilise a camera. This applies multiple actuators external to the camera physically to counteract rotation, often allowing for unconstrained rotation about the camera.

Image stabilisation in the context of optic flow (or used with other equivalent algorithms) in effect provides isolation of motion. The isolation of motion due to camera translation from motion due to rotation, improving the accuracy of algorithms that are concerned with the motion of the scene around the camera. This ensures that regions of interest in the world remain in the same part of the visual field as the camera tilts/pans/yaws, simplifying algorithms that can benefit from spatial coherence between frames.

The benefit of unconstrained electronic image stabilization/electronic gimbal is that there are no moving parts, power-efficient, and real-time or near real-time operation that is close to zero processing delay (less than 1/10th of the frame period).

Having unconstrained electronic image stabilization is amenable to FPGA or computer vision accelerator chip (unit) implementation, as opposed to CPU or GPU. In effect, the unconstrained electronic image stabilization emulates the stabilisation achieved in nature using eye/neck/body actuation, enabling the use of nature-derived algorithms that rely on having a stabilised image as their input.

### Data Structures for Encoding the Field of View

It is often necessary for an object/robot/sensor to sense the visual information surrounding it, i.e. to capture its field of view of the world. This is achieved typically by sampling the scene at a number of discrete points, each point representing a pixel on the visual field. This has the effect of dividing the visual scene into a number of tessellated pixels, in which each pixel typically represents the mean illumination of the part of the scene falling under this pixel. This subdivision and the shapes of these pixels can take an infinite number of forms. Still, some projections have advantages over others, for example, in terms of even pixel coverage, consistent pixel shapes, pixel layout, computational representation, and the complexity of performing further computational operations on the data stored in these representations. In the rotationally stabilised case, the orientation of this grid will often remain constant, with information from moving cameras projected onto this grid.

A gamut of projections may be used for storing fields of view, such as rendering and modelling tools that included but are limited to, for example, cube maps, UV spheres, unicube maps, icospheres and goldberg polyhedrons. The ideal projection would exhibit the following properties: Locally Cartesian pixels; Equi-area pixels; An efficient binning algorithm—minimal transcendental operations; Continuous—no singularities; No distortion—objects must have the same representation in the projection when viewed through any part of the field of view; Efficient representation in memory; Efficient means of querying connected pixel neighbours; Efficient means of sampling different regions of the field of view at different resolutions, whilst still allowing spatial operations to span regions of differing resolution; Alignment of pixel horizontal boundaries in the region about the equator, allowing these to be aligned with the horizon.

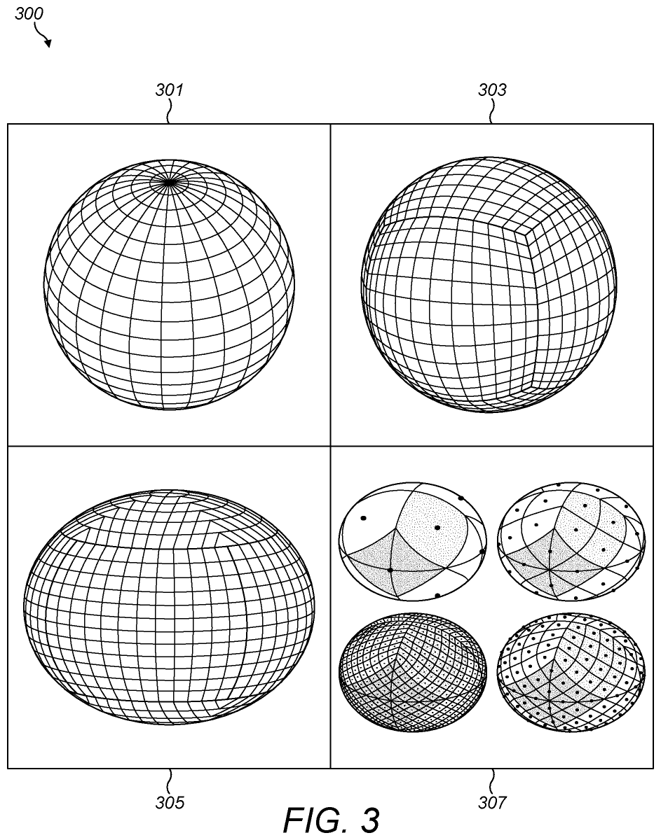

These properties associated with spherical encoding data are detailed and compared in Table 1 below, along with the notable projections. In the table, projection with “Y” benefits from or acquires (at least inherently) the listed properties while “-” does not. The importance of each of these properties, in relation to the present invention, is provided elsewhere in this application. Pictorial examples of some of the projections are shown in FIG. 3.

TABLE 1

| | | | | | | Pixel | |
|---|---|---|---|---|---|---|---|
| | | | | | | edges | |
| | Amenable | Equi-area | Quadrilateral | No | Equilatitude | align to | Locally |
| | Computation | pixels | pixels | singularities | pixels | horizon | Cartesian |
| UV Sphere | y | — | y | — | y | y | — |
| Cube map | y | — | y | y | y | y | — |
| Cylindrical | y | — | y | — | y | y | — |
| Icosphere | — | y | — | y | — | — | — |
| Goldberg | — | — | — | y | — | — | — |
| Polyhedron | | | | | | | |
| Unicube | y | y | y | y | — | — | — |
| Isocube | ? | y | — | y | y | y | — |
| HEALPix | y | y | y | y | y | — | y |
| HEALPix | y | y | y* | y | y | y | y |
| double | | | | | | | |
| pixelisation | | | | | | | |

In Table 1, some pixels degenerate into triangular pixels shown as “y*” but retain four neighbour pixels, and so can still be traversed as if they are truly quadrilateral.

### Computation on a Rotationally Stabilised Image

Optic flow estimation is one of a wide range of algorithms that extracts temporal/motion data from a sequence of images. Motion in an image sequence captured within a stationary world will be due to one of two sources: motion due to translation of the camera through the world, or motion due to rotation of the camera in the world. While motion due to translation is dependent on scene geometry, motion due to rotation can be exactly computed from knowledge of the camera's rate of rotation, and so this can be compensated for in the output of the optic flow algorithm. While this can work for some algorithms, it requires the optic flow estimator to possess a large dynamic range and low estimation noise, as camera motion due to rotation will often be significantly larger than the smaller signals generated by translation.

### Efficient Computation on a Spherical Image

Cube maps have long been used in 3D rendering as a means of capturing a spherical field of view onto a 2D grid suitable for efficient computation. While visually, this is a sufficient solution for 3D rendering applications, this approach exhibits a number of properties undesirable for encoding a system's field of view, for example, uneven pixel sampling, inconsistent pixel sizes and shapes, and varying layout of neighbouring pixels. While other spherical projections have been developed to address these issues, such as JPL's HEALPix, these often concern more with performing computations on small regions of the sphere, rather than applying a single computation to the entire projection in one pass.

Existing spherical projections designed for efficient computation are typically concerned with efficient computation in small regions of the sphere, for example, in spherical harmonic analysis, rather than in applying a single computation to the entire projection in one pass.

### Electronic Image Stabilisation

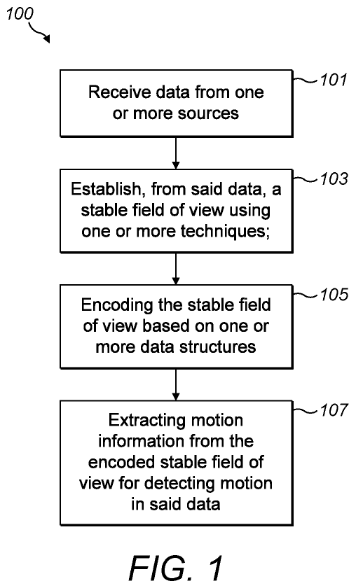

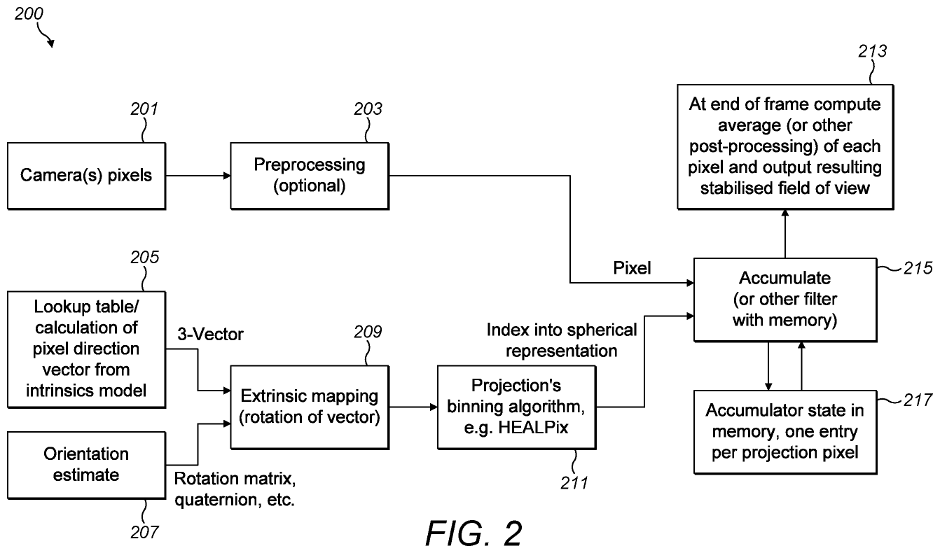

In one example of the present invention, each camera frame or set of frames from synchronised cameras is stabilised to a single frame in the output field of view. The manner in which each individual camera pixel is stabilised is shown in FIGS. 1 and 2.

Camera pixels are streamed into the algorithm. Image processing may be applied to the camera images before they are fed into the stabilisation algorithm, for example, to implement debayering, relative illumination compensation, or other common image processing algorithms.

The Implementation of debayering such as by individually accumulating pixel channels when downsampling may help avoid the need to debayer camera data prior to image stabilization, freeing up hardware/software resources.

For each camera pixel, a unit vector describes the direction into the world frame scene from which it samples data when in a specific reference orientation. This vector can be calculated from the camera's intrinsic and extrinsic models. This calculation can be performed online for every pixel to produce this data as it is needed, or it can be performed once at the start of operation or offline, with the results stored into a lookup table (LUT). The unit vector for a given pixel can then be efficiently queried from this LUT, avoiding the repetition of the same calculations between frames.

A measurement of the orientation of the camera relative to the base frame from which its extrinsic mapping is calculated is provided to the image stabilisation algorithm. By rotating the unit vector associated with each pixel by this relative rotation it is possible to calculate the direction in the world frame from which each camera pixel is sampling or sampled.

This unit vector (or equivalent coordinates, e.g. spherical azimuth & elevation) will map to a pixel in the stabilised projection (e.g. a spherical projection) used to encode the system's stabilised field of view. Multiple camera pixels may map to the same spherical projection pixel, or none may map to it. The index of the pixel in the spherical representation is found as a function of the camera pixel's unit vector, termed the binning function. When no camera pixels map to a spherical representation pixel that pixel can be left blank, it can retain its previous data, or its value can be interpolated from that of neighbouring pixels. When multiple pixels are assigned to a stabilised representation pixel a filter can be used to combine their data, either iteratively or at the end of a frame, for example, taking the mean. This could be implemented by accumulating into memory as the pixels of a frame stream in, then taking the mean for each stabilised representation pixel at the end of the frame.

For collocated cameras (or adequately close to collocated for the specific application) this approach provides a method of image stitching, in that multiple cameras can contribute data to the same part of the stabilised internal representation if their fields of view are overlapping. This technique could also be applied to non-collocated cameras if a discontinuity in the field of view is accepted and/or accounted for.

### Encoding a (Robot's, Sensor's, Etc.) Field of View

Considering the advantages of the attributes listed above (amenable computation of binning algorithm, equi-area pixels, no singularities, equi-latitude pixels, pixel edges that align to the horizon, and locally Cartesian pixel arrangement) we selected the HEALPix double pixelisation algorithm as a possible approach. However, it is also understood that similar representations (e.g. isocube) or variations on these that share some of these important properties. Even distribution and area of pixels in this field of view is important for accurate optic flow computation (and similar), and the equi-latitude property and horizontal pixel boundaries in the +/−45° elevation area around the equator are useful for mapping the results of these computations to the world's Cartesian axes.

The use of a spherical projection for representing a (robot's) field of view_in general provides a means of capturing the entire visual field of a robot and for combining data from multiple cameras. Similarly, the use of a spherical projection with locally Cartesian and equi-area pixels provides a means of capturing the entire visual field of a robot in a form that allows for efficient computation on the field of view with consistent scaling of results.

In implementing the HEALPix algorithm, it is possible to simplify computation by using power of 2 N_SIDE parameters, as this allows a number of divisions and multiplies to be replaced with bit shifts. This is especially useful for FPGA implementations of this algorithm, such as our fixed-point implementation. It is also possible to implement the algorithm in 16-bit floating-point precision for use on a vision accelerator chip such as the Movidius Myriad X, again for which using power of 2 N_SIDE parameters allows for algorithm simplification through direct manipulation of the floating-point exponent.

Some advantages of using the HEALPix projection for representing a (robot's) field of view are as follows:
Binning algorithm is amenable to efficient implementation on FPGA/ASIC, requiring the evaluation of only a single transcendental function (arctan);
Equi-area pixels—even sampling of the visual scene, meaning objects retain the same apparent size when viewed from different directions. This means that spatial relations between pixels, for example, computing optic flow between them, retain the same scale between any two adjacent pixels in the representation;
No singularities—unlike cylindrical or UV projections HEALPix remains well-defined in all directions;
Locally Cartesian pixels—It is often necessary to compute vectors on the surface of the sphere, which in a local region of the sphere, are 2D vectors. If a pixel and its neighbours are arranged orthogonally in this local region, i.e. they are locally Cartesian, and then an algorithm computing these two vectors can often be separated into two 1D computations, as by being orthogonal the two directions are linearly separable for many algorithms. Without this property, for example, motion exactly parallel to the line between a pixel and its neighbour in one direction will also be measured between the pixel and next two neighbours CW and CCW from the first. As the relationship between movement in the scene and movement between these neighbours is no longer linearly separable, it is impossible to recover the correct 2D vector for this pixel without computing both directions simultaneously, preventing the separation of the 2D algorithm into two 1D algorithms
Equilatitude pixels—Many algorithms are concerned with horizontal scene motion, and so having pixels that are arranged in horizontal rings in a region about the equator can simplify computation;
Efficient heterogeneous sampling—HEALPix pixels can be recursively subdivided to increase sampling resolution in an area of interest, or combined to reduce sampling in areas with less information;

The use of the HEALPix double pixelisation projection for representing a (robot's) field of view provides further benefits:
Pixel edges align to the horizon—when combined with the locally Cartesian and equilatitude pixel properties this allows for a continuous band of sampling about a circle of latitude, upon which algorithms can be implemented. Without this property, a point moving horizontally about the projection may appear to move up and down in the field of view as it moves between two parallel rows of pixels.
The structure of this projection lends itself to the division of the sphere into three orthogonal bands, in which each pixel is sampled at least once along each of the pixel's local Cartesian axes. A small percentage of pixels are sampled thrice at the band boundaries.

As through image stabilization the mapping between the camera pixels and pixels in the field of view is known, it is possible to sample areas on the field of view at a greater temporal frequency by reversing this mapping and sampling the associated camera pixels at a higher rate. It is also possible to sample at an area on the field of view at a high spatial resolution by subdividing this region. This could be performed iteratively and in multiple regions to have many nested regions of varying levels of detail. This is useful for allowing a system to gather more information from interesting areas of a scene, for example, where an object exists, whilst minimising processing of the less interesting areas.

The field of view does not only have to encode visual information—this can be used as a structure upon which data from other sources are stored. This could be other types of sensor data, for example, other spectrums of light, light polarisation information, outputs from RADAR, LIDAR, depth sensors or similar, or it could be metadata about the visual field, for example, labelling pixels to perform image segmentation or tracking bounding boxes of objects in the field of view.

Extracting Three Bands from a Field of View as a Means of Performing a 1D/2D Filter or Similar Computation on the Field of View

Many computer vision applications and algorithms involve 1D or 2D computation across a 2D image, for example, convolution with a 2D kernel. When applying these same techniques to data stored across an entire field of view a method of accessing this spherical (or similar) data as a 2D matrix about each point of the field of view is required. This can broadly be approached by treating the field of view as being composed of three ‘bands’ of 2D data wrapping around each of the Cartesian axes, such that each pixel on the field of view is sampled by at least two bands. In the case of a cube map representation of the field of view these would comprise faces (1,2,3,4), (1,5,3,6), and (5,2,6,4), where faces (1,3), (2,4), and (5,6) are opposing. An algorithm can then be applied to each of these three bands in turn, resulting in the computation of two data points per field of view pixel, for example, representing a 2D vector on the field of view. The pixel indices forming these bands can be calculated offline or at boot and stored in a lookup table, or can be calculated on-the-fly. The bands may be processed in a parallel manner. In one example, the system is configured to perform the same computation on the three bands simultaneously, or additionally or alternatively splitting a band into sections for parallel evaluation of the algorithm.

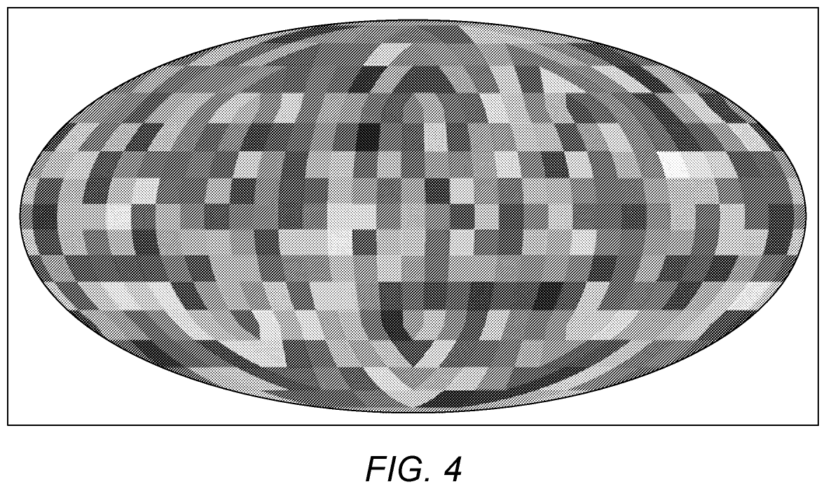

This approach can be applied to or together with the HEALPix double pixelisation projection, along with some of the other similar projections discussed above (e.g. HEALPix, unicube, etc.). This allows the combination of the aforementioned advantages of these projections with the efficient implementation of 1D/2D computation on the sphere. This could easily be extended to an n-D computation that also draws inputs from other sources, for example, an internal state, previous frames, or previous state data. Examples of these bands for N_SIDE=4 are shown in FIGS. 4-12.

In effect, the extraction of three orthogonal bands of pixels from a spherical field of view (esp. HEALPix double pixelisation projection) provides an efficient means for performing 2D or 1D operations on the sphere by treating each of the three bands as a 1D operation.

### Pre-Processing Training Datasets as a Means to Use Existing Datasets to Train Machine Learning Models to Perform Inference on Data Encoded in Spherical Data Structures

The system may include a pre-processing step of applying machine learning (ML) training data as a means for capturing the input data via herein described data structure, such as datasets of labelled images. This may be a means for using existing training datasets to train machine learning models or techniques that are to operate on the stabilized data structure, where the imaged objects may exhibit different properties/features to those in the original training dataset. In turn, the ML model(s) may be adapted to operate on said one or more data structures to update model features in accordance with said one or more data structures.

The updated features are used by the ML model(s) to classify one or more objects in said data based on said one or more data structures, where said one or more ML models are configured to recognise the object representative of said encoding associated with the stable field of view. In one example, an ML model is trained to recognise cars on the spherical data structure. A requisite dataset of the spherical data structure containing cars and associated labels may be used for the training. This method is different and superior to a generic ML model trained on an existing dataset of labelled cars. Any image used to train the generic ML model would exhibit properties/features (i.e. resolution, pixel shape, distortion) different from properties/features generated via the ML model(s) applying the spherical data structure.

To train the ML model, instead of manually capturing and labelling/annotating a dataset encoded in a FoV data structure, images of cars could be fed directly (or indirectly via minor pre-processing) into one or more data structures as if they were camera inputs, whilst also transforming the existing set of labels to our data structure coordinate system. This produces a dataset suitable for training a model that is to operate on the FoV data structure, without requiring any further data capture. That is, said one or more ML models are trained using data annotated with one or more objects, where the annotated data is transformed using said one or more data structures for training the ML models. Additionally or alternatively, a labelled output dataset may be generated for the training of a machine learning model from a dataset of labelled sensor inputs, where the machine learning model is configured to operate on said data encoded using said one or more data structures.

Example(s) of ML models or techniques used by the system may include or be based on, by way of example only but is not limited to, one or more of: any ML technique or algorithm/method that can be used to generate a trained model based on a labelled and/or unlabelled training datasets; one or more supervised ML techniques; semi-supervised ML techniques; unsupervised ML techniques; linear and/or non-linear ML techniques; ML techniques associated with classification; ML techniques associated with regression and the like and/or combinations thereof. Some examples of ML techniques/model structures may include or be based on, by way of example only but is not limited to, one or more of active learning, multitask learning, transfer learning, neural message parsing, one-shot learning, dimensionality reduction, decision tree learning, association rule learning, similarity learning, data mining algorithms/methods, artificial neural networks (NNs), autoencoder/decoder structures, deep NNs, deep learning, deep learning ANNs, inductive logic programming, support vector machines (SVMs), sparse dictionary learning, clustering, Bayesian networks, types of reinforcement learning, representation learning, similarity and metric learning, sparse dictionary learning, genetic algorithms, rule-based machine learning, learning classifier systems, and/or one or more combinations thereof and the like.

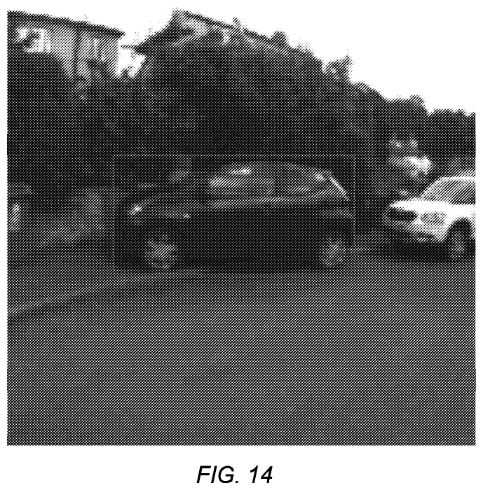

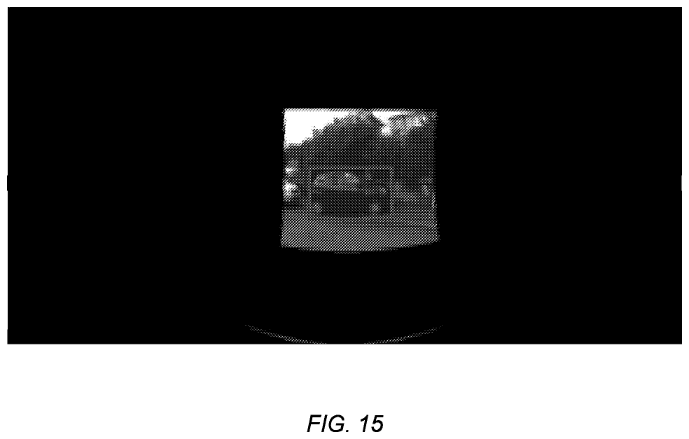

Example(s) of the data that is annotated or labelled for the purpose of training or applying with any of the herein describe ML model(s) or ML technique(s) include labelled images from a training dataset as shown in FIGS. 14 and 15. Depicted in FIGS. 14 and 15 are annotated images. These annotated images are a part of a training dataset used to train an ML model for classifying vehicles.

FIG. 1 is a flow diagram illustrating an example process or methods of stabilising data for motion detection. In particular, the described presenting the data in a representational format (or as a projection) for computation with optics flow-like algorithm. From one or more sources, the data associated with the object is received. A rotationally stable field of view is established from the received data using one or more techniques. The stable field of view is encoded based on one or more data structures. The data structures comprise at least one 2D projection or 3-dimensional projection adapted from the 2D projection with depth information. From the encoding, motion data is extracted. This motion data is used for detecting the motion of the objection from the data associated.

In step 101, receiving data associated with the objects or moving objects from one or more sources. Such sources may one or more types of sensors associated with a device, robot, or sensor system of a machine. The sensor system may comprise one or more modules. Said one or more sources might be various types of cameras. The sources are configured to sense the visual information surrounding, for example, a robot capturing data associated with the field of view. Sources may collect image data by sampling the scene at a number of discrete points, with each point representing a pixel on the visual field. The data from one or more sources may be demosaiced. That is, the data may be processed with de-mosaicing algorithms to reconstruct data colouring when the data is non-RGB data or RGB data lacking complete colouring.

Any data received from one or more sources may be RGB data corresponding to visual information or non-RGB data, where the non-RGB data are associated with non-colour information, for example, data from or associated with spectrums of light, light polarisation information, outputs from RADAR, LIDAR, depth perception, ultrasonic distance information from a distance sensor, temperature, and metadata such as semantic labelling, bounding box vertices, terrain type, or zoning such as keepout areas, time-to-collision information, collision risk information, auditory, olfactory, somatic, or any other forms of directional sensor data, intermediate processing data, output data generated by algorithms, or data from other external sources. Respective sources for receiving this data are accommodated based on whether it is RGB data and non-RGB data. Conventional steps to pre-process the data into suitable formats may be taken in relation to such accommodation, for example, treating RADAR samples as pixelated data.

Additionally or alternatively, techniques such as pixel binning and downsampling may be applied in establishing a stable field of view, where the view is a rotationally stabilised omnidirectional. In one example, the pixel binning is configured for debayering said data by separately accumulating three colour channels.

In step 103, establishing, from said data, a rotationally stable field of view using one or more techniques. The techniques may include algorithms configured to create a rotationally stabilised omnidirectional field of view from the said data based on the orientation of said one or more sources. Additionally or alternatively, the techniques may further comprise algorithms configured to perform rolling shutter correction. The algorithms may do so by compensating for rolling shutter artefacts in said data by updating the camera pose for each individual row of pixels in each camera frame. These techniques may also be used in respect of heterogeneous sensing in accordance with a data structure or projection, for example, the use of the nested nature of HEALPix's pixels.

Additionally or alternatively, simulated data may be inserted, superimposed, or in some other manner combined or integrated into the field of view as a means to emulate a real world stimulus. The simulated data may be part of the input data or as a separate stream of data. In one example, the system may simulate the appearance of an object in what is actually an empty room. This is similar to applying alternate reality. The use of simulated data may be applicable to any herein described data types and sensing modalities/sources.

These techniques may process said input data, whether RGB or non-RGB, by adding received data iteratively in a continuous manner to establish a stable field of view. For example, the pixels are consumed in a streaming manner, with each pixel being added to the stabilized frame in an iterative manner. This streaming is unique in that the entire camera image never has to be stored anywhere, i.e. it is not buffered to memory—it is consumed on-the-fly. This could be done on-the-fly or with partially or fully buffered architectures. That is, the processed data may be, at least partially, stored in memory, or is processed in real-time without storing said data in memory.

In step 105, encoding the stable field of view based on one or more data structures, wherein said one or more data structures comprise at least one 2-dimensional or 3-dimensional projection. The 3-dimensional projection may be an adaptation of the 2-dimensional projection. The encoding may be used to assess the isolated translational motion from rotational motion from said encoding to extract motion data. The translation motion may be isolated when the field of view is stabilised.

One or more data structures may be a spherical projection, cylindrical projection, or a pseudo cylindrical projection. The data structures may be an equi-area projection and/or locally Cartesian projection or with equi-area and locally Cartesian properties associated. The spherical projection of the object moves with a source(s) such as a robot or a device to the extent that stable fields of view may be at least partially non-stabilised in relation to the moving object. The spherical projection may comprise properties such as equal pixel area and locally Cartesian nature to which the motion data extracted using a motion estimation algorithm may benefit. The algorithm may learn with respect to these properties of the spherical projection representing the robot's field of view for capturing the entire visual field of the robot and for combining data from multiple cameras. This in turn allows for efficient computation on the field of view with consistent scaling of results. An algorithm may be optic/optical flow, or the like. Based on properties associated with the equi-area projection and the locally Cartesian projection, the motion data is extracted using the algorithm.

Additionally or alternatively, a data structures for encoding the stable field of view may be a (single) Hierarchical Equal Area isoLatitude Pixelization (HEALPix) projection or a double pixelisation derivative of the HEALPix projection. The HEALPix projection may be applied with a 2\hat{ }n HEALPix N_SIDE parameters. The use of the HEALPix single or double pixelisation algorithm as a structure on which optic flow is computed also benefits from the properties of equal pixel area and locally Cartesian nature. These benefits are entailed in the above sections and throughout this application.

The data structure for encoding purposes may be tailored to a specified type of hardware such as FPGA or vision accelerator unit or any other hardware logical components herein described. In one example, on an FPGA, a fixed-point implementation of the HEALPix and HEALPix double pixelisation may be applied. The 2\hat{ }n HEALPix N_SIDE parameters may be used to simplify divides and multiplies by the implementation of bitshifts. In another example, the implementation of HEALPix on a vision accelerator unit using FP16 mathematics may also be equally applicable given the use of 2\hat{ }n HEALPix N_SIDE parameters to simplify divides and multiplies by the implementation as addition/subtraction of the exponent. The applications of the data structure in hardware such as FPGA and vision accelerator unit are superior to generic CPU implementation in terms of both performance and speed. This is particularly the case with HEALPix type data structures and implementations.

In a further example, orthogonal bands may be extracted in relation to said one or more data structure associated with a spherical projection, wherein the orthogonal bands are about the identifiable Cartesian axes of the spherical projection. Three orthogonal bands may be extracted. In the case where the spherical projection is HEALPix, either single or double pixelisation. The extraction of three orthogonal bands wrapping around the HEALPix (or similar) sphere about the three Cartesian axes. The enabling of efficient band extraction by use of double pixelisation. In addition, the use of three orthogonal bands as a means for performing a 2D convolution on the sphere projection by separating this into three 1D convolutions around each band, in which the rings of each band are treated as being connected end-to-end to form a single 1D line of pixels. Effectively, 1D convolutions around each of the orthogonal bands are generated to improve the performance of the 2D convolution. Any kind of spatial filtering on a sphere by use of band structure (being orthogonal) may also be supplemented.

In addition, orthogonal bands may be extracted in relation to said one or more data structures associated with other projections such as a cylindrical projection. In a cylindrical projection, the orthogonal bands are about the identifiable Cartesian axes of the cylindrical projection in a manner to capture a direction based on vertical strips. These vertical strips would be used the same way as the orthogonal bands. That is, if the north and south (pole) sections of the vertical bands are removed, the vertical bands could be used in the same manner as the orthogonal bands. For a cylindrical projection the image would be represented as a looped 2D grid of pixels in which the image rows are connected to themselves at either end of each row, which would be processed by first looping around the rows, then looping the columns.

During or after the encoding process, heterogeneous sensing may be introduced to the stable field of view as established, where the stable field of view is omnidirectional. It is established by one or more techniques such as those described herein. Heterogeneous sensing enables sampling only some or certain areas of the field of view at a greater spatial or temporal resolution. That is, at least part of the stable field of view at a higher spatial resolution or sampling over regions of the stable field of view dynamically.

In terms of HEALPix projection, single or double pixelisation, heterogeneous sensing utilises the nested nature of HEALPix's pixels. This allows for controlling one or more camera to sample one or more regions of interest on the sensor plane more frequently. The heterogeneous sensing is configured to sample more frequently from a region of interest from said data to provide a sampling rate associated with said region, where said region associated with a higher sampling rate can be dynamically movable and resizable on the stable field of view. Different regions may comprise different sampling rates. During heterogeneous sensing, one or more HEALPix pixels may be divided to increase the spatial resolution of the stable field of view.

Alternatively and additionally, a region of interest in the HEALPix data structure may be identified. The identified region may be used to generate a reverse mapping to extract the raw camera data associated with this part of the field of view from the next camera frame. In particular, information on which parts of this higher resolution image may be mapped to which pixel in the field of view data structure. This mapping enables the implementation of maximal-resolution heterogeneity. The data generated associated with the mapping may be represented as a separate 2D image rather than being incorporated into the main visual field data structure. The mapping may be used to encode the data structure.

In step 107, extracting motion data from the encoded stable field of view for detecting motion in said data. The extraction may be accomplished via an optic flow or like algorithms that estimate the motion of an object. The extracted motion data considers the properties such as equi-area and the locally Cartesian and are associated with such projections. This motion detection may be performed on a system comprising one or more modules, devices, or apparatus associated with one or more source. The motion detection may be computed directly on such sources. The system, device, apparatus may be a detector, a part of a robot or a drone-type device, comprising an interface for receiving data from one or more sources and one or more integrated circuits configured to: establish, from said data, a stable field of view using one or more techniques; encode the stable field of view based on one or more data structures, wherein said one or more data structures comprise 3-dimensional projections; and extract motion data from the encoded stable field of view to detect object motion in said data.

FIG. 2 is a schematic diagram illustrating an example of data stabilisation. FIG. 2 depicts how each individual camera pixel is stabilised. In the figure, camera pixels 201 are received by an accumulator (or other filters with memory) 215. The camera pixels 201 may be optionally pre-processed 203 for improved pixel quality before being received by the accumulator.

Additionally or alternatively, image processing may be applied to the camera images. The image processing or an image processor may include the use of image stabilisation algorithms such as debayering, relative illumination compensation and the like. In this process, a pixel direction vector 205 from the camera's intrinsic (and extrinsic models) may be calculated by performing online/real-time or as retrieved from a lookup table that is populated offline. The lookup table provides efficient query, avoiding repeated calculations between frames. Real-time performance accommodates hardware limitations.

An estimation of the orientation 207 of the camera, for example, in the form of a rotation matrix, relative to the base frame from which its extrinsic mapping 209 is calculated or computed. This is also provided to the image stabilisation algorithm along with the pixel direction vector 205. By rotating the unit vector associated with each pixel, by this relative rotation, using the extrinsic mapping 209, the image stabilisation algorithm calculates the direction in the world frame from which each camera pixel is sampled.

More specifically, the pixel direction vector (or equivalent coordinates, e.g. spherical azimuth & elevation) will map to a pixel in the stabilised projection (e.g. a spherical projection) used to encode the system's stabilised field of view. For example, multiple camera pixels may map to the same spherical projection pixel. The index of the pixel in the spherical representation will be found as a function of the camera pixel's direction (unit) vector, termed the binning function 211. A filter or accumulator 215 may be used to combine data from multiple cameras. In a different example where no camera pixels map to a spherical representation pixel, or pixel can be left blank, the system can retain its previous value or interpolate this missing data.

The combination may be achieved iteratively or at the end of a frame, for example, by taking the mean. This could be implemented by accumulating into memory 217 as the pixels' of a frame stream in, then taking the mean for each stabilised representation pixel at the end of frame 213.

When using multiple collocated cameras (or when using non-collocated cameras if a discontinuity in the field of view is accepted) the above aspects of the present invention effectively stitches the images, in that the cameras contribute to the same part of the stabilised internal representation, benefiting from the overlapping fields of view.

FIG. 3 is a pictorial diagram illustrating examples of 2-D projections. In the figure are four projections: UV Sphere 301, Cube Map 303, Isocube 305, and HEALPix 307. HEALPix 307 are further shown in separate presentations. Properties or attributes associated with the projections are detailed in Table 1. Based on the properties (amenable computation of binning algorithm, equi-area pixels, no singularities, equi-latitude pixels, pixel edges that align to the horizon, and locally Cartesian pixel arrangement) the HEALPix double pixelisation algorithm may prove superior in certain situations. As with HEALPix double pixelisation, the other projections from Table 1 may be used for even distribution and area of pixels in this field of view to compute using optic flow (and similar algorithm). The equi-latitude property and horizontal pixel boundaries in the +/−45deg elevation area around the equator are useful for mapping the results of these computations to the world's Cartesian axes.

FIGS. 4 to 12 and are pictorial diagrams of various projections of Double pixelisation HEALPix implementation. Different projections are shown for the Double pixelisation HEALPix to which could be implemented with the present invention. Specifically, Double pixelisation HEALPix projections may be a Mollweide projection, which is an equal-area pseudo-cylindrical map projection, or may be an Orthographic projection, which produces a circular mapping with a chosen point on the globe tangent to the flat surface at its centre.

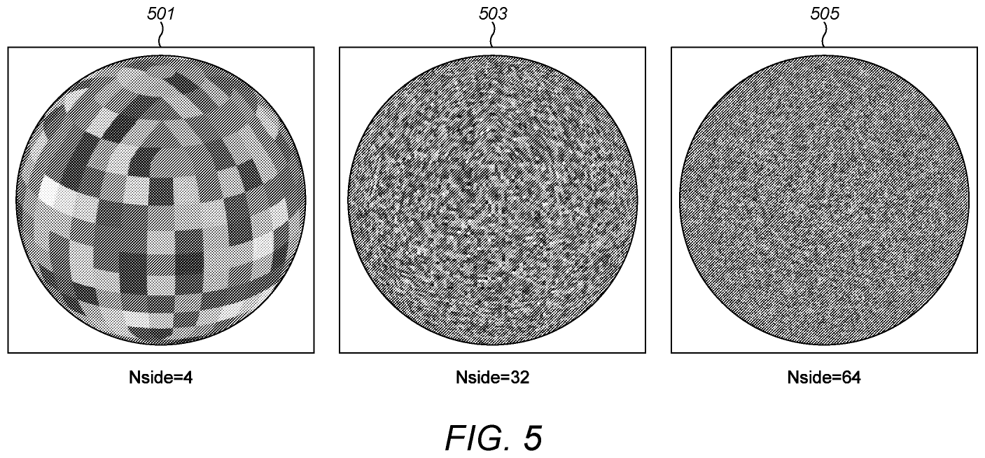

FIGS. 4, 7, 8, 9, and 10 show a Mollweide projection with different N_SIDE parameters, boundaries, and bands. FIGS. 5, 6, 11, and 12 show an orthographic projection with the same. N_SIDE parameters equal to positive integer powers of 2 are used for simplicity of computation allowing a number of divisions and multiplications to be replaced with bit shifts. This is particularly beneficial for an FPGA implementation. In addition, this allows for algorithm simplification through direct manipulation of the floating-point exponent—this benefits implementation in 16-bit floating-point precision on a vision accelerator unit.

FIG. 4 illustrates an example of Double pixelisation HEALPix with N_SIDE=4, visualised using a Mollweide projection. FIG. 5 illustrates an example double pixelisation HEALPix with N_SIDE, orthographic projection. double pixelisation HEALPix with N_SIDE=4, 32, and 64 are shown as part of the projections, respectively as 501, 503, and 505.

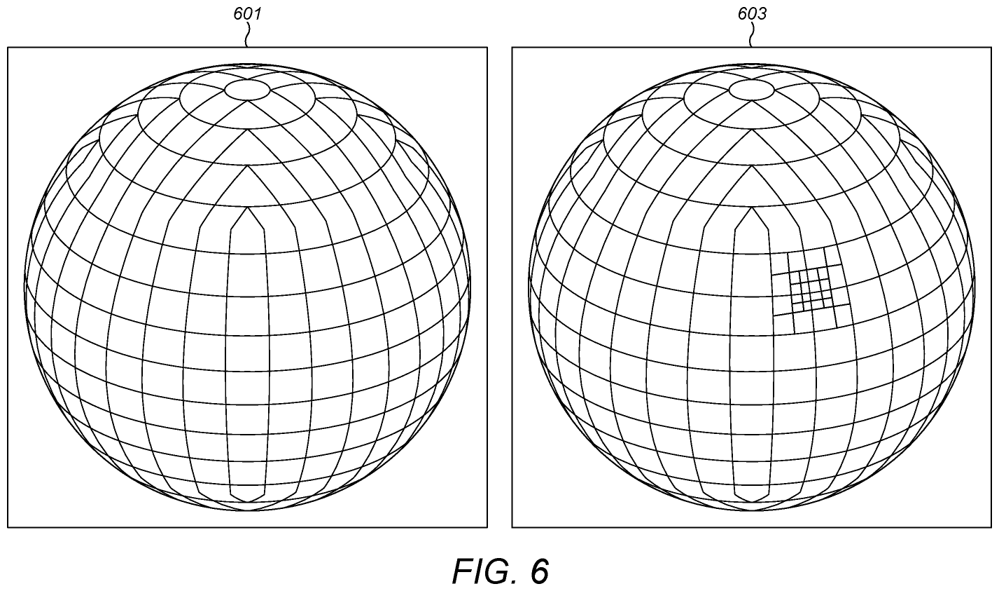

FIG. 6 illustrates an example of double pixelisation HEALPix pixel boundaries, using an orthographic projection. An application of heterogeneous sensing is also shown on the projection. In particular, the left projection 601 is without heterogeneous sensing and on the right projection 603 is with heterogeneous sensing exhibited. For heterogeneous sensing, each additional pixel is generated by an equal-area four-way subdivision of a larger pixel, where each new or larger pixel may be subdivided repeatedly, forming the four-way subdivision.

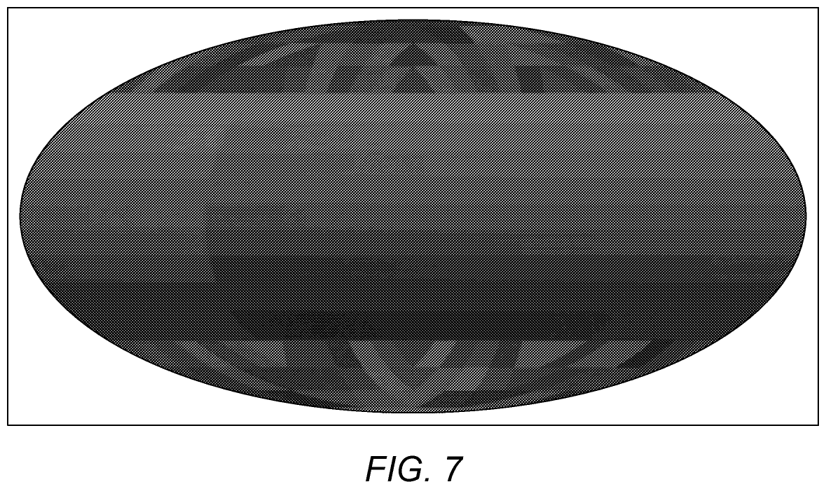

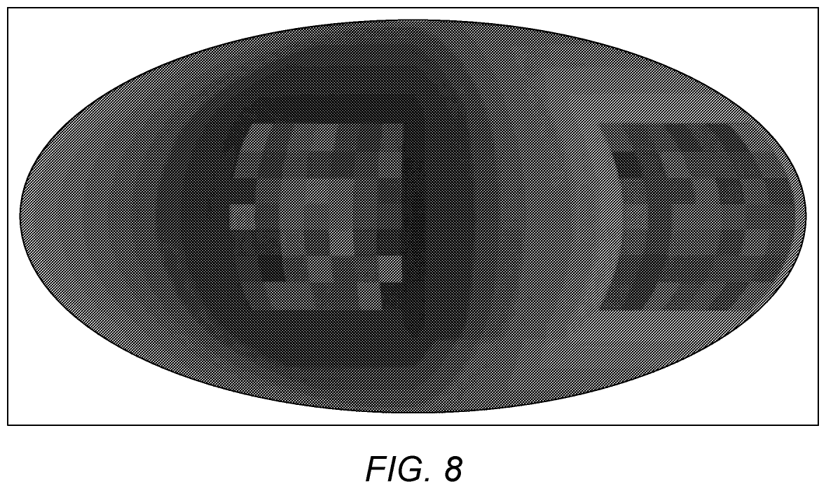

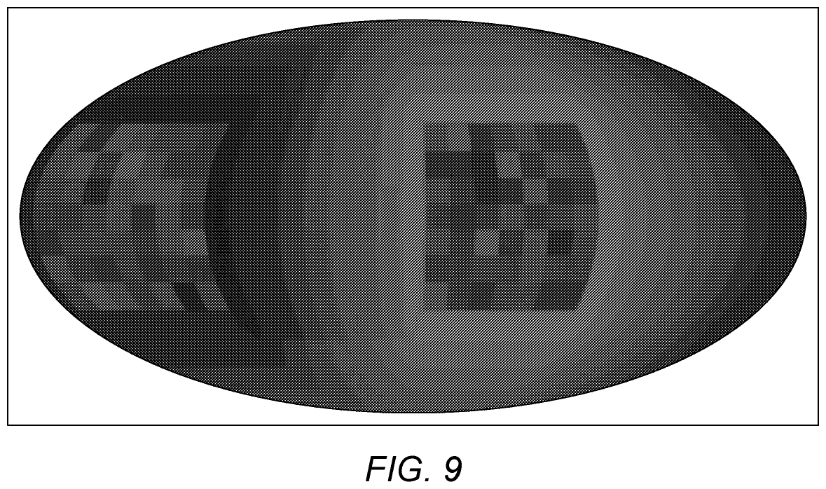

FIG. 7 is a schematic diagram illustrating an example of Double pixelisation HEALPix with band 0 highlighted. FIG. 8 illustrates an example of Double pixelisation HEALPix with band 1 highlighted. FIG. 9 illustrates an example of Double pixelisation HEALPix with band 2 highlighted. FIGS. 7, 8, and 9 are shown in terms of Mollweide projections. Each pixel in the band is assigned a brightness proportional to its index in the band structure—pixel 0 is black, and the final pixel is the brightest. Pixels outside of the band are assigned random brightnesses for visualisation purposes.

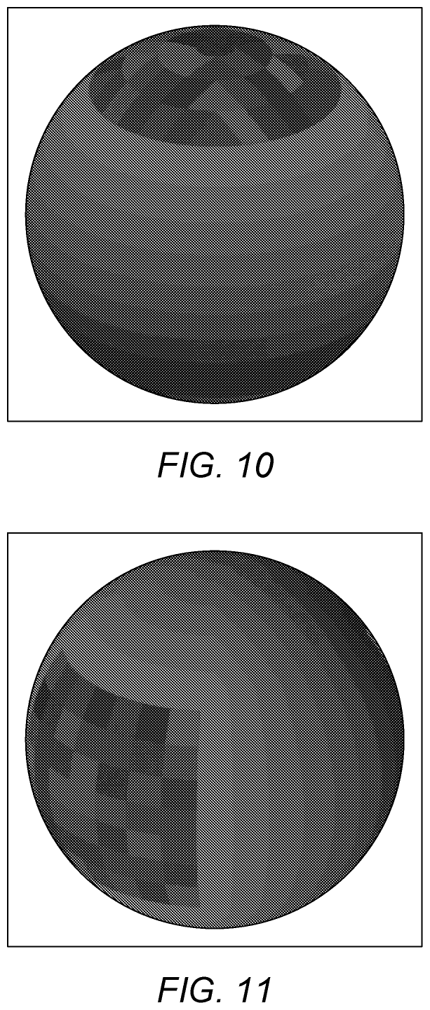

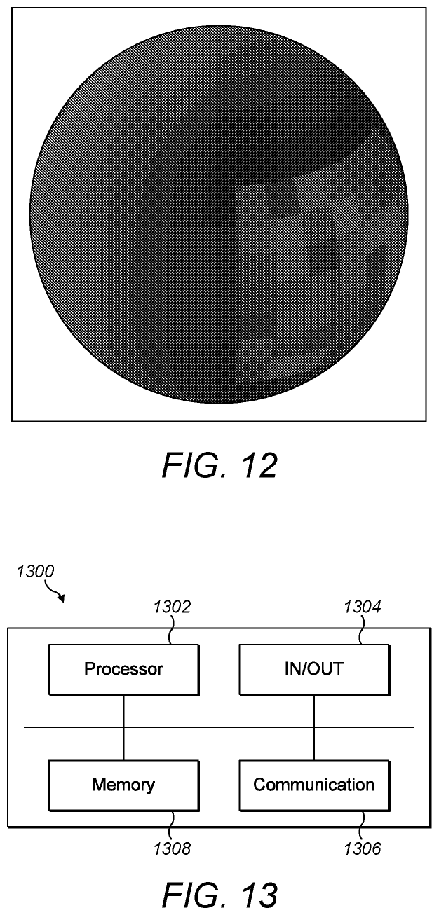

FIG. 10 illustrates an example of Double pixelisation HEALPix with band 0 highlighted. FIG. 11 illustrates an example of Double pixelisation HEALPix with band 1 highlighted. FIG. 12 illustrates an example of Double pixelisation HEALPix with band 2 highlighted. FIGS. 10, 11, and 12 are shown in terms of orthographic projections. FIGS. 10, 11, and 12 correspond to FIGS. 7, 8, and 9 with respect to the number of bands.

FIG. 13 is a block diagram illustrating an example computing apparatus/system 400 that may be used to implement one or more aspects of the present invention, apparatus, method(s), and/or process(es) combinations thereof, modifications thereof, and/or as described with reference to FIGS. 1 to 12 and/or as described herein. Computing apparatus/system 1300 includes one or more processor unit(s) 1302, an input/output unit 1304, communications unit/interface 1306, a memory unit 1308 in which the one or more processor unit(s) 1302 are connected to the input/output unit 1304, communications unit/interface 1306, and the memory unit 1308. In some embodiments, the computing apparatus/system 1300 may be a server, or one or more servers networked together. In some embodiments, the computing apparatus/system 1300 may be a computer or supercomputer/processing facility or hardware/software suitable for processing or performing the one or more aspects of the system(s), apparatus, method(s), and/or process(es) combinations thereof, modifications thereof, and/or as described with reference to FIGS. 1 to 12 and/or as described herein. The communications interface 1306 may connect the computing apparatus/system 1300, via a communication network, with one or more services, devices, the server system(s), cloud-based platforms, systems for implementing subject-matter databases and/or knowledge graphs for implementing the invention as described herein. The memory unit 1308 may store one or more program instructions, code or components such as, by way of example only but not limited to, an operating system and/or code/component(s) associated with the process(es)/method(s) as described with reference to FIGS. 1 to 12, additional data, applications, application firmware/software and/or further program instructions, code and/or components associated with implementing the functionality and/or one or more function(s) or functionality associated with one or more of the method(s) and/or process(es) of the device, service and/or server(s) hosting the process(es)/method(s)/system(s), apparatus, mechanisms and/or system(s)/platforms/architectures for implementing the invention as described herein, combinations thereof, modifications thereof, and/or as described with reference to at least one of the FIGS. 1 to 12.

FIG. 14 is a grey-scaled image showing cars parked on the side of a street and a rectangular bounded box surrounding one of the cars, where the bounded box serves as a point of reference for the object detection and creates a collision box for that object. In the figure, the car surrounded by the bounded box is annotated and labelled. The image may be part of a larger training dataset of different types of vehicles. The training dataset may be suitable for the training of an ML-based classifier or any machine vision algorithm.

FIG. 15 is the same grey-scaled image of the car after pre-processing with a Mollweide projection. The figure shows how the system applies the Mollweide projection to transform the original annotated image of the car to the pre-processed adaptation shown in the figure. The rest or surrounding FoV is shown in black background colour subject to the Mollweide projection. The FoV in relation to the projection is shown at the centre of the image. The training dataset, including the original image in FIG. 14, may be encoded by one or more data structures described herein, illustrating a pre-processing step for herein described ML applications.

The above FIGS. 14 and 15 illustrate exemplary training data that may be used with one or more ML models herein described and applicable to be used directly or indirectly with any one or more aspects of the present invention and in accordance with FIGS. 1 to 13.

One aspect of the present invention is a computer-implemented method of stabilising data for motion detection comprising: receiving data associated with the objects from one or more sources; establishing, from said data, a rotationally stable field of view using one or more techniques; encoding the stable field of view based on one or more data structures, wherein said one or more data structures comprise at least one, two or more dimensional projection; and extracting motion data from the encoded stable field of view for detecting motion in said data.

Another aspect of present invention is an apparatus for detecting motion, comprising: an interface for receiving data from one or more sources; one or more integrated circuits configured to: establish, from said data, a stable field of view using one or more techniques; encode the stable field of view based on one or more data structures, wherein said one or more data structures comprise a two or more dimensional projection; and extract motion data from the encoded stable field of view to detect object motion in said data.

Another aspect of present invention is a system for detecting motion, comprising: a first module configured to establish, from said data, a stable field of view using one or more techniques; a second module configured to encode the stable field of view based on one or more data structures, wherein said one or more data structures comprise a two or more dimensional projection; and a third module configured to extract motion data from the encoded stable field of view for detecting object motion in said data.

Another aspect of present invention is a computer-readable medium comprising computer readable code or instructions stored thereon, which when executed on a processor, causes the processor to implement the computer-implemented method according to any of the preceding aspects.

It is understood that the following options may be combined with any of the above described aspects.

As an option, said one or more techniques comprise algorithms configured to create a rotationally stabilised omnidirectional field of view from the said data based on the orientation of said one or more sources.

As another option, said one or more techniques further comprise algorithms configured to correct rolling shutter from said data.

As another option, said one or more techniques process said data by iteratively adding received data in a continuous manner to establish the stable field of view.

As another option, the processed data is at least partially stored in memory; or wherein the received data is processed in real-time without storing said data in memory.

As another option, further comprising: isolating translational motion from rotational motion from said encoding to extract motion data.

As another option, said one or more data structures comprise a spherical projection or a cylindrical projection.

As another option, the spherical projection of the object moves with said one or more sources.

As another option, the stable fields of view is at least partially non-stabilised in relation to a moving object.

As another option, said one or more data structures comprise a Hierarchical Equal Area isoLatitude Pixelization (HEALPix) projection.

As another option, the HEALPix projection applies a HEALPix double pixelisation derivative.

As another option, further comprising: applying a 2\hat{ }n HEALPix n_side parameters with the HEALPix projection.

As another option, said motion data is extracted using an algorithm for estimating motion, wherein the algorithm is configured with respect to properties of equal pixel area and locally Cartesian nature.

As another option, said motion data is extracted using optical flow.

As another option, said one or more data structures comprise an equi-area projection and/or locally Cartesian projection.

As another option, said motion data is extracted using optic flow type estimation based on properties associated with the equi-area projection and the locally Cartesian projection.

As another option, the method is implemented on a field-programmable gate array using a fixed-point implementation.

As another option, the method is implemented on a vision accelerator unit using 16-bit floating-point arithmetic

As another option, the method is implemented on one or more processors associated with at least one of: a central processing unit, a graphics processing unit, a tensor Processing Unit, a digital signal processor, an application-specific integrated circuit, a fabless semiconductor, a semiconductor intellectual property core, or a combination thereof.

As another option, further comprising: extracting orthogonal bands in relation to said one or more data structure associated with a spherical projection, wherein the orthogonal bands are about the identifiable Cartesian axes of the spherical projection.

As another option, the spherical projection is HEALPix.

As another option, the spherical projection applies a double pixelisation.

As another option, further comprising: applying spatial filtering on the spherical projection by use of the orthogonal bands.

As another option, further comprising: performing a 2D convolution on the spherical projection by generating 1D convolutions around each of the orthogonal bands to improve said performance of the 2D convolution.

As another option, further comprising: extracting orthogonal bands in relation to said one or more data structure associated with a cylindrical projection, wherein the orthogonal bands are about the identifiable Cartesian axes of the cylindrical projection in a manner to capture a direction based on vertical strips of said data.

As another option, data from one or more sources are demosaiced.

As another option, further comprising: applying pixel binning and downsampling to create a rotationally stabilised omnidirectional field of view.

As another option, the data is RGB data corresponding to visual information.

As another option, the pixel binning is configured for debayering said data by separately accumulating three colour channels.

As another option, further comprising: applying heterogeneous sensing to the stable field of view, wherein the stable field of view is omnidirectionally established based on one or more techniques.

As another option, heterogeneous sensing comprises encoding at least part of the stable field of view at a higher spatial resolution.

As another option, further comprising: sampling over regions of the stable field of view dynamically based on the heterogeneous sensing.

As another option, the heterogeneous sensing is applied in relation to a HEALPix projection or a double pixelisation.

As another option, the heterogeneous sensing is configured to sample more frequently from a region of interest from said data to provide a sampling rate associated with said region, wherein said region associated with a higher sampling rate can be dynamically movable and resizable on the stable field of view, wherein different regions comprise different sampling rates.

As another option, further comprising: dividing one or more HEALPix pixels of said data to increase spatial resolution of the stable field of view.

As another option, said data comprise RGB data and non-RGB data, wherein the non-RGB data are associated with non-colour information.

As another option, the non-RGB data comprise data associated with spectrums of light, light polarisation information, outputs from RADAR, LIDAR, depth perception, ultrasonic distance information from a distance sensor, temperature, and metadata such as semantic labelling, bounding box vertices, terrain type, or zoning such as keepout areas, time-to-collision information, collision risk information, auditory, olfactory, somatic, or any other forms of directional sensor data, intermediate processing data, output data generated by algorithms, or data from other external sources.

In a further option, further comprising: extracting orthogonal bands in relation to said one or more data structure associated with a spherical projection, wherein the extracted orthogonal bands are adapted to be applied with an algorithm associated with a projection, wherein the extracted orthogonal bands are used as encodings on said one or more data structures.

In a further option, the orthogonal bands applied simultaneously to generate convolutions in a parallel manner based on a spherical projection.

In a further option, each of the orthogonal bands are segmented for parallel processing to generate convolutions associated with a spherical projection.

In a further option, further comprising: identifying an area of interest on an encoded stable field of view based on a N-1th data frame of said data, wherein said data comprise at least a plurality of data frames; mapping said area of interest to a N^{th} data frame of said data; and extracting a subset of data from said data based on the mapping.

In a further option, the extracted subset of data is represented by a 2D image independent of the encoded stable field of view.

In a further option, the mapping is continuously updated to implement maximal-resolution heterogeneity, wherein the mapping is at least partially adapted to encode the stable field of view.

In a further option, said one or more sources comprise at least one camera, sensor, or device suitable for receiving external data directly or indirectly.

In a further option, further comprising: receiving simulated data in relation to one or more simulations, wherein the simulated data are used to establish the stable field of view by means of insertion or superposition of the simulated data to said data.

In a further option, the said data comprise simulated data corresponding to said one or more sources for establishing the stable field of view with said data.

In a further option, further comprising: generating said data using one or more machine learning (ML) models configured to select from a set of training data associated with an ML model based on said one or more data structures.

In a further option, said one or more ML models are adapted to operate on said one or more data structures to update model features in accordance with said one or more data structures.

In a further option, applying one or more machine learning (ML) models to classify an object in said data based on said one or more data structures, wherein said one or more ML models configured to recognise the object representative of said encoding associated with the stable field of view.

In a further option, said one or more ML models are trained using data annotated with one or more objects, wherein the annotated data is transformed using said one or more data structures for training the ML models.

In a further option, generating a labelled output dataset for the training a machine learning model from a dataset of labelled sensor inputs, wherein the machine learning model configured to operate on said data encoded using said one or more data structure.

In the embodiments, examples, and aspects of the invention as described above such as process(es), method(s), system(s) and/or apparatus for motion detection using the present invention may be implemented on and/or comprise one or more cloud platforms, one or more server(s) or computing system(s) or device(s). A server may comprise a single server or network of servers, the cloud platform may include a plurality of servers or network of servers. In some examples the functionality of the server and/or cloud platform may be provided by a network of servers distributed across a geographical area, such as a worldwide distributed network of servers, and a user may be connected to an appropriate one of the network of servers based upon a user location and the like.

The above description discusses embodiments of the invention with reference to a single user for clarity. It will be understood that in practice the system may be shared by a plurality of users, and possibly by a very large number of users simultaneously.

The embodiments described above may be configured to be semi-automatic and/or are configured to be fully automatic. In some examples a user or operator of the querying system(s)/process(es)/method(s) may manually instruct some steps of the process(es)/method(es) to be carried out.

The described embodiments of the invention a system, process(es), method(s) and/or apparatus for motion detection and the like according to the invention and/or as herein described may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example, where a system on a chip architecture is used, the processors may include one or more fixed function blocks (also referred to as accelerators) which implement a part of the process/method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium or non-transitory computer-readable medium. Computer-readable media may include, for example, computer-readable storage media. Computer-readable storage media may include volatile or non-volatile, removable or non-removable media implemented in any method or technology for storage of information such as computer-readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection or coupling, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Application-specific Integrated Circuits (ASICs), Application-specific Standard Products (ASSPs), System-on-a-chip systems (SoCs). Complex Programmable Logic Devices (CPLDs), quantum computers, neuromorphic processors, photonic processors, etc.

The hardware logical components may comprise one or more processors associated with at least one of: a central processing unit, a graphics processing unit, a tensor Processing Unit, a digital signal processor, an application-specific integrated circuit, a fabless semiconductor, a semiconductor intellectual property core such as complementary metal-oxide-semiconductor, or a combination thereof.

Although illustrated as a single system, it is to be understood that the computing device may be a distributed system. Thus, for instance, several devices may be in communication by way of a network connection and may collectively perform tasks described as being performed by the computing device.

Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, IoT devices, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary”, “example” or “embodiment” is intended to mean “serving as an illustration or example of something”. Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art.

What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1. A computer-implemented method for stabilising motion data, the method comprising:
receiving data associated with the objects from one or more sources;
establishing, from said data, a rotationally stable field of view using one or more techniques;
encoding the stable field of view based on one or more data structures, wherein said one or more data structures comprise at least one, two or more dimensional projection; and
extracting stable motion data from the encoded stable field of view.

2. The method of claim 1, wherein said one or more techniques comprise algorithms configured to create a rotationally stabilised omnidirectional field of view from the said data based on the orientation of said one or more sources.

3. The method of any preceding claims, wherein said one or more techniques further comprise algorithms configured to correct rolling shutter from said data.

4. The method of any preceding claims, wherein said one or more techniques process said data by iteratively adding received data in a continuous manner to establish the stable field of view.

5. The method of claim 4, wherein the processed data is at least partially stored in memory; or wherein the received data is processed in real-time without storing said data in memory.

6. The method of any preceding claims, further comprising: isolating translational motion from rotational motion from said encoding to extract motion data.

7. The method of any preceding claims, wherein said one or more data structures comprise a spherical projection or a cylindrical projection.

8. The method of claim 7, wherein the spherical projection of the object moves with said one or more sources.

9. The method of claim 7 or 8, wherein the stable fields of view is at least partially non-stabilised in relation to a moving object.

10. The method of any preceding claims, wherein said one or more data structures comprise a Hierarchical Equal Area isoLatitude Pixelization (HEALPix) projection.

11. The method of claim 10, wherein the HEALPix projection applies a HEALPix double pixelisation derivative.

12. The method of claim 10 or 11, further comprising: applying a 2\hat{ }n HEALPix n_side parameters with the HEALPix projection.

13. The method of claims 10 to 12, wherein said motion data is extracted using an algorithm for estimating motion, wherein the algorithm is configured with respect to properties of equal pixel area and locally Cartesian nature.

14. The method of claims 10 to 13, wherein said motion data is extracted using optical flow.

15. The method of claims 1 to 14, wherein said one or more data structures comprise an equi-area projection and/or locally Cartesian projection.

16. The method of claim 15, wherein said motion data is extracted using optic flow type estimation based on properties associated with the equi-area projection and the locally Cartesian projection.

17. The method of any preceding claims, wherein the method is implemented on a field-programmable gate array using a fixed-point implementation.

18. The method of claims 1 to 16, wherein the method is implemented on a vision accelerator unit using 16-bit floating-point arithmetic.

19. The method of claims 1 to 16, wherein the method is implemented on one or more processors associated with at least one of: a central processing unit, a graphics processing unit, a tensor Processing Unit, a digital signal processor, an application-specific integrated circuit, a fabless semiconductor, a semiconductor intellectual property core, or a combination thereof.

20. The method of any preceding claims, further comprising: extracting orthogonal bands in relation to said one or more data structure associated with a spherical projection, wherein the orthogonal bands are about the identifiable Cartesian axes of the spherical projection.

21. The method of claim 20, wherein the spherical projection is HEALPix.

22. The method of claim 20 or 21, wherein the spherical projection applies a double pixelisation.

23. The method of claims 20 to 22, further comprising: applying spatial filtering on the spherical projection by use of the orthogonal bands.

24. The method of claims 20 to 23, further comprising:
performing a 2D convolution on the spherical projection by generating 1D convolutions around each of the orthogonal bands to improve said performance of the 2D convolution.

25. The method of claims 1 to 19, further comprising: extracting orthogonal bands in relation to said one or more data structure associated with a cylindrical projection, wherein the orthogonal bands are about the identifiable Cartesian axes of the cylindrical projection in a manner to capture a direction based on vertical strips of said data.

26. The method of claims 1 to 19, further comprising: extracting orthogonal bands in relation to said one or more data structure associated with a spherical projection, wherein the extracted orthogonal bands are adapted to be applied with an algorithm associated with a projection, wherein the extracted orthogonal bands are used as an encoding on said one or more data structure.

27. The method of claims 20 to 25, wherein the orthogonal bands applied simultaneously to generate convolutions in a parallel manner based on a spherical projection.

28. The method of claim 27, wherein each of the orthogonal bands are segmented for parallel processing to generate convolutions associated with a spherical projection.

29. The method of any preceding claims, wherein data from one or more sources are demosaiced.

30. The method of claim 29, wherein the data is RGB data corresponding to visual information.

31. The method of any preceding claims, further comprising: applying pixel binning and downsampling to create a rotationally stabilised omnidirectional field of view.

32. The method of claim 31, wherein the pixel binning is configured for debayering said data by separately accumulating three colour channels.

33. The method of any preceding claims, further comprising: applying heterogeneous sensing to the stable field of view, wherein the stable field of view is omnidirectionally established based on one or more techniques.

34. The method of claim 33, wherein heterogeneous sensing comprises encoding at least part of the stable field of view at a higher spatial resolution.

35. The method of claim 33 or 34, further comprising: sampling over regions of the stable field of view dynamically based on the heterogeneous sensing.

36. The method of claims 33 to 35, wherein the heterogeneous sensing is applied in relation to a HEALPix projection or a double pixelisation.

37. The method of claims 33 to 36, wherein the heterogeneous sensing is configured to sample more frequently from a region of interest from said data to provide a sampling rate associated with said region, wherein said region associated with a higher sampling rate can be dynamically movable and resizable on the stable field of view, wherein different regions comprises different sampling rates.

38. The method of claims 33 to 37, further comprising: dividing one or more HEALPix pixels of said data to increase spatial resolution of the stable field of view.

39. The method of any preceding claims, further comprising:
identifying an area of interest on an encoded stable field of view based on a N-1^{th} data frame of said data, wherein said data comprise at least a plurality of data frames;
mapping said area of interest to a N^{th} data frame of said data; and
extracting a subset of data from said data based on the mapping.

40. The method of claim 39, wherein the extracted subset of data is represented by a 2D image independent of the encoded stable field of view.

41. The method of claim 39 or 40, wherein the mapping is continuously updated to implement maximal-resolution heterogeneity, wherein the mapping is at least partially adapted to encode the stable field of view.

42. The method of any preceding claims, wherein said data comprise RGB data and non-RGB data, wherein the non-RGB data are associated with non-colour information.

43. The method of claim 42, wherein the non-RGB data comprise data associated with spectrums of light, light polarisation information, outputs from RADAR, LIDAR, depth perception, ultrasonic distance information, temperature, metadata such as semantic labelling, bounding box vertices, terrain type, or zoning such as keepout areas, time-to-collision information, collision risk information, auditory, olfactory, somatic, or any other forms of directional sensor data, intermediate processing data, output data generated by algorithms, or data from other external sources.

44. The method of any preceding claims, wherein said one or more sources comprise at least one camera, sensor, or device suitable for receiving external data directly or indirectly.

45. The method of any preceding claim, further comprising: receiving simulated data in relation to one or more simulations, wherein the simulated data are used to establish the stable field of view by means of insertion or superposition of the simulated data to said data.

46. The method of any preceding claim, wherein the said data comprise simulated data corresponding to said one or more sources for establishing the stable field of view with said data.

47. The method of any preceding claim, further comprising: applying one or more machine learning (ML) models to classify an object in said data based on said one or more data structures, wherein said one or more ML models configured to recognise the object representative of said encoding associated with the stable field of view.

48. The method of claim 47, wherein said one or more ML models are trained using data annotated with one or more objects, wherein the annotated data is transformed using said one or more data structures for training the ML models.

49, The method of any preceding claim, further comprising: generating a labelled output dataset for the training a machine learning model from a dataset of labelled sensor inputs, wherein the machine learning model is configured to operate on said data stored and encoded by said one or more data structure.

50. An apparatus for stabilising motion data, comprising:
an interface for receiving data from one or more sources;
one or more integrated circuits configured to:
establish, from said data, a stable field of view using one or more techniques;
encode the stable field of view based on one or more data structures, wherein said one or more data structures comprise a two or more dimensional projection; and
extract stable motion data from the encoded stable field of view to detect object motion in said data.

51. The apparatus of claim 50, wherein said one or more integrated circuits are configured to perform method steps of any of the claims 1 to 49.
